(19) United States
(12) Patent Application Publication
(10) Pub. No.: US 2008/0137264 A1
(43) Pub. Date: Jun. 12, 2008

(54) Electronic Device, Multilayer Ceramic Capacitor and the Production Method Thereof

(75) Inventors: Kazutaka Suzuki, Chiba (JP); Shingeki Sato, Chiba (JP)

Correspondence Address: OLIFF & BERRIDGE, PLC, P.O. BOX 320850, ALEXANDRIA, VA, 22320-4850, US

(73) Assignee: TDK Corporation, Tokyo (JP)

(21) Appl. No.: 11/597,564

(22) PCT Filed: Apr. 22, 2005
(86) PCT No.: PCT/JP2005/007706

§ 371 Date: Nov. 27, 2006

(30) Foreign Application Priority Data
May 31, 2004 (JP) 2004-161344

(51) Int. Cl. H01G 4/06; H01G 9/00

(52) U.S. Cl. 361/321.3; 29/25.03

(57) ABSTRACT

An electronic device, such as a multilayer ceramic capacitor, capable of suppressing grain growth of metal particles in a firing step, effectively preventing spheroidizing of internal electrode layers and breaking of electrodes and effectively suppressing a decline of a capacitance, and the production method are provided: wherein the production method of an electronic device including internal electrode layers and dielectric layers comprises the steps of forming a pre-fired internal electrode thin film having a dielectric thin film and a metal thin film; stacking green sheets to be dielectric layers after firing and the internal electrode thin films; and firing a multilayer body of said green sheets and said internal electrode thin films.

### BACKGROUND OF THE INVENTION

1. Field of the Invention

The present invention relates to an electronic device, a multilayer ceramic capacitor and the production method and, particularly, relates to an electronic device and a multilayer ceramic capacitor capable of responding to attaining a thinner layers and downsizing.

2. Description of the Related Art

A multilayer ceramic capacitor as an example of electronic devices comprises an element body having a multilayer structure, wherein a plurality of dielectric layers and internal electrode layers are alternately arranged, and a pair of external terminal electrodes formed on both ends of the element body.

The multilayer ceramic capacitor is produced by forming a pre-fired element body by alternately stacking a plurality of pre-fired dielectric layers and pre-fired internal electrode layers exactly by necessary numbers, firing the result and, then, forming a pair of external terminal electrodes on both end portions of the fired element body.

A ceramic green sheet, etc. produced by the sheet method and the stretching method is used for the pre-fired dielectric layers. The sheet method is a method for producing by applying dielectric slurry including a dielectric powder, binder, plasticizer and organic solvent, etc. to a carrier sheet, such as PET, by using the doctor blade method, etc. and heating to dry. The stretching method is a method for producing by performing biaxial stretching on a film-shaped molded body obtained by extrusion molding of a dielectric suspending solution obtained by mixing dielectric powder and a binder in a solvent.

The pre-fired internal electrode layers are formed by using the printing method for printing internal electrode paste including a metal powder and a binder on the ceramic green sheet explained above in a predetermined pattern, or by the thin film formation method using plating, vapor deposition or sputtering, etc. to form a metal thin film in a predetermined pattern on the green sheet. Particularly, when forming by a metal thin film obtained by the thin film formation method, the internal electrode layer can be made thinner, so that a multilayer ceramic capacitor can be made to be more compact and thinner with a larger capacity.

As explained above, when producing a multilayer ceramic capacitor, the pre-fired dielectric layers and pre-fired internal electrode layers are fired at a time. Therefore, a conductive material included in the pre-fired internal electrode layers is required to have a higher melting point than a sintering temperature of the dielectric powder included in the pre-fired dielectric layers, not to react with the dielectric powder and not to diffuse in the fired dielectric layers.

In recent years, along with downsizing of a variety of electronic devices, multilayer ceramic capacitors to be installed inside the electronic devices have become downsized and come to have a larger capacity. To attain such downsizing and a larger capacity of multilayer ceramic capacitors, the internal electrode layers have been required to be thinner as well as the dielectric layers. As a method of obtaining thinner internal electrode layers, a method of forming the pre-fired internal electrode layers by a metal thin film obtained by the thin film formation method may be mentioned (for example, the patent article 1: The Japanese Patent Publication No. 3491639).

This patent article 1 discloses a production method of a multilayer ceramic capacitor by forming a second metal layer including ceramic particles by the composite plating method on a first metal layer formed by a thin film formation method. According to the production method disclosed in the article, by forming the second metal layer functioning as an adhesive layer in addition to the first metal layer to be an internal electrode layer after firing, delamination of the internal electrode layer and dielectric layer after firing can be prevented. However, since the second metal layer includes dielectric particles, the thickness cannot be thinner than a particle diameter of the dielectric particles, so that there has been a limit in making the multilayer ceramic capacitor thinner by the invention disclosed in the article.

Also, as a conductive material to be included in the pre-fired internal electrode layers, a base metal nickel is preferably used because of the relatively low price, etc. However, since nickel has a lower melting point comparing with that of the dielectric powder included in the pre-fired dielectric layers, when firing the pre-fired dielectric layers and pre-fired internal electrode layers at a time, there arises a difference in sintering temperatures of the both. In the case where the sintering temperatures are largely different as such, when firing is performed at a high temperature, nickel particles included in the conductive material become spheroidized due to particle growth and cavities arise at arbitrary places, consequently, it becomes difficult to form fired internal electrode layers in a continuous form. When fired internal electrode layers are not in a continuous form as above, capacitance of the multilayer ceramic capacitor tends to decline. Particularly, this tendency becomes notable when the pre-fired internal electrode layers are made to be thinner, such that the pre-fired internal electrode layers are formed by a metal thin film obtained by the thin film formation method. Thus, it has been difficult to attain a downsized multilayer ceramic capacitor with a larger capacity.

### SUMMARY OF THE INVENTION

An object of the present invention is to provide an electronic device, such as a multilayer ceramic capacitor, capable of suppressing grain growth of metal particles in a firing stage, effectively preventing spheroidizing of internal electrode layers and breaking of electrodes and effectively suppressing a decline of capacitance, particularly, even when a thickness of the internal electrode layers is made thinner; and a production method thereof.

In a production method of a multilayer ceramic capacitor and other electronic devices having internal electrode layers and dielectric layers, the present inventors found that the above object can be attained by forming as a pre-fired internal electrode thin film an internal electrode thin film having a dielectric thin film and a metal thin film, stacking the internal electrode thin films with green sheets to be the dielectric layers after firing, forming a multilayer body, and firing the multilayer body; and completed the present invention.

Namely, according to the present invention, there is provided a production method of an electronic device for producing an electronic device including internal electrode layers and dielectric layers, comprising the steps of:

forming a pre-fired internal electrode thin film having a dielectric thin film and a metal thin film;

stacking a green sheet to be a dielectric layer after firing and the internal electrode thin film; and

firing a multilayer body of the green sheet and the internal electrode thin film.

According to the present invention, there is provided a production method of a multilayer ceramic capacitor having an element body, wherein internal electrode layers and dielectric layers are alternately stacked, comprising the steps of:

forming a pre-fired internal electrode thin film having a dielectric thin film and a metal thin film;

alternately stacking green sheets to be dielectric layers after firing and the internal electrode thin films; and

firing a multilayer body of the green sheets and the internal electrode thin films.

Note that, in the present invention, the dielectric thin film in the pre-fired internal electrode thin film is not particularly limited but at least one kind of BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃ are included.

In the present invention, an internal electrode thin film having a dielectric thin film and a metal thin film is formed as a pre-fired internal electrode thin film for composing an internal electrode layer after firing. Therefore, it is possible to prevent spheroidizing of internal electrode layers caused by a difference of sintering temperatures of the dielectric material and the metal material, preventing breaking of electrodes, and effectively suppressing a decline of capacitance, which have been significant disadvantages when the fired internal electrode layer is made thinner.

Note that, in the present invention, the dielectric thin film is a thin film including a dielectric material as its main component and may include other components than the dielectric. Also, the metal thin film is a thin film including a material having conductivity, such as a metal material, as its main component and may include other components than the metal material. Also, the dielectric thin film and the metal thin film included in the internal electrode thin film form an internal electrode layer after firing, but a part of the dielectric thin film may form a dielectric layer after firing.

The internal electrode thin film can be formed, for example, by a method of forming a film directly on a green sheet to be a dielectric layer after firing or by a method of forming a film on a release layer including a dielectric material, etc.

In the production method of the present invention, it is preferable to use the transfer method for forming the internal electrode thin film on the release layer, then, forming an adhesive layer on the internal electrode thin film, and bonding the internal electrode thin film and the green sheet via the adhesive layer.

In the present invention, at least, the pre-fired internal electrode thin film includes one layer of dielectric thin film and one layer of metal thin film, but preferably the metal thin film is sandwiched between a pair of dielectric thin films, so that each of the pre-fired internal electrode thin films has a multilayer structure of three or more layers. As a result, the dielectric thin film and the green sheet, both including dielectric as their main components, directly contact with each other, so that adhesiveness on the contact surfaces can be improved and the effects of the present invention are enhanced. Particularly, delamination of the internal electrode layers and dielectric layers after firing can be effectively prevented.

Alternately, in the present invention, the dielectric thin film may be sandwiched between a pair of the metal thin films and each of the pre-fired internal electrode thin films has a multilayer structure of three or more layers. As a result, diffusion of the dielectric material into the internal electrode layers after firing can be promoted, so that the effects of preventing spheroidizing of the internal electrode layers caused by adding the dielectric material can be furthermore enhanced.

In the present invention, preferably, the pre-fired internal electrode thin film may have a multilayer structure formed by a plurality of the dielectric thin films and a plurality of the metal thin films. In that case, for example, by alternately stacking the dielectric thin films and the metal thin films, the pre-fired internal electrode thin film can become a multilayer body formed by a large number of layers (for example, 3 to 29 layers or so). Note that, in the pre-fired internal electrode thin film, an outer layer for directly contacting with the green sheet may be formed by the dielectric thin film or by the metal thin film. Furthermore, one outer layer and the other outer layer may be formed by the same kind of thin film or by different kinds of thin films. However, particularly in the present invention, it is preferable to form both of the outer layers by a dielectric thin film.

As explained above, by forming the pre-fired internal electrode layer to be a multilayer body having a large number of layers comprising a plurality of the dielectric thin films and a plurality of the metal thin films and by forming the outer layers by the dielectric thin film, the effects of the present invention can be particularly enhanced. Namely, in this case, by stacking a plurality of the dielectric thin films and the metal thin films, the metal material and the dielectric materials can be uniformly dispersed in the internal electrode layer after firing, so that spheroidizing of the internal electrode layers can be effectively prevented. Moreover, since the outer layers are formed by the dielectric thin film, adhesiveness of contact surfaces of the dielectric thin film (outer layer) and the green sheet can be improved and delamination of the internal electrode layers and dielectric layers after firing can be effectively prevented.

In the present invention, preferably, a total thickness (t1) of the metal thin films in each of the internal electrode thin films is 0.1 to 1.0 μm, more preferably 0.1 to 0.5 μm. By setting the thickness of the metal thin film to be in the ranges, the pre-fired internal electrode thin film can be made thinner, moreover, the fired internal electrode layer can be made thinner.

In the present invention, preferably, a total thickness (t2) of the dielectric thin films in each of the internal electrode thin films is 0.02 to 0.2 μm. When the thickness of the dielectric thin film is too thin, it is liable that the effects of the present invention explained above cannot be obtained, while when too thick, a content ratio of the dielectric material in the internal electrode thin film becomes too high and breaking of electrodes in the internal electrode layers tends to increase.

In the present invention, preferably, a ratio (t2/t1) of a total thickness (t1) of the metal thin films in each of the internal electrode thin films and a total thickness (t2) of the dielectric thin films in each of the internal electrode thin films is 0.05 to 1, more preferably 0.05 to 0.5.

In the present invention, the thickness (t1) of the metal thin films and the thickness (t2) of the dielectric thin films respectively mean a total thickness thereof in an internal electrode thin film. Accordingly, for example, when two layers of the dielectric thin films are formed on an internal electrode thin film, a total thickness of the two layers is the thickness (t2) of the dielectric thin films.

In the present invention, preferably, the dielectric thin film is formed to be in a predetermined pattern by the thin film formation method. As the thin film formation method, for example, the plating method, vapor deposition method and sputtering method, etc. may be mentioned. The sputtering method is particularly preferable.

Also, a method of forming the metal thin film is not particularly limited and may be suitably selected in accordance with a thickness of a thin film to be formed. For example, the printing method for printing conductive paste to be a predetermined pattern and thin film formation methods, such as a plating method, vapor deposition method and sputtering method, may be mentioned. In the present invention, the metal thin film is preferably formed by the thin film formation method, and the sputtering method is more preferable.

By forming the dielectric thin films and the metal thin films by the thin film formation method, particularly by the sputtering method, the dielectric thin film and the metal thin film can be made thinner. Particularly, by forming both of the dielectric thin film and the metal thin film by the thin film formation method, the dielectric thin film and the metal thin film can be bonded tightly, so that adhesiveness of the both thin films can be improved and, moreover, arising of a clearance between contact surfaces of both of the thin films can be effectively prevented.

In the present invention, it is preferable that the dielectric thin film and the green sheet respectively include dielectric having substantially the same composition. By doing so, adhesiveness of the dielectric thin film and green sheet can be furthermore improved and the effects of the present invention are enhanced. Note that, in the present invention, the dielectric to be included in the dielectric thin film and that in the green sheet are not always required to have the completely same composition and it is sufficient if the compositions are substantially the same. Also, the dielectric thin film and/or the green sheet may be respectively added with different subcomponents in accordance with need.

As the dielectric to be included in the dielectric thin film and the green sheet, for example, calcium titanate, strontium titanate and barium titanate, etc. may be mentioned. Among them, barium titanate is preferably used.

Also, as additive subcomponents to be included in the pre-fired internal electrode thin film and/or the green sheet, for example, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃, etc. may be mentioned.

In the present invention, preferably, the metal thin film is a metal thin film including nickel and/or a nickel alloy as its main component. As the nickel alloys, alloys at least one kind of element selected from ruthenium (Ru), rhodium (Rh), rhenium (Re) and platinum (Pt) with nickel are preferable, and a nickel content in the alloys is preferably 87 mol % or larger.

In the present invention, preferably, the multilayer body is fired in an atmosphere having an oxygen partial pressure of 10⁻¹⁰ to 10⁻² Pa at a temperature of 1000° C. to 1300° C. According to the present invention, spheroidizing of internal electrodes and breaking of electrodes, which become significant disadvantages when firing at a higher temperature than the sintering temperature of the metal material, can be effectively prevented, so that firing at the temperature as above becomes possible.

Preferably, after firing the multilayer body, annealing is performed in an atmosphere having an oxygen partial pressure of 10⁻² to 100 Pa at a temperature of 1200° C. or lower. By performing annealing under a specific condition after the firing, re-oxidization of the dielectric layers is attained, the dielectric layers are prevented from becoming semiconductor, and high insulation resistance can be obtained.

An electronic device according to the present invention is produced by any one of the above methods.

The electronic device is not particularly limited, and a multilayer ceramic capacitor, piezoelectric device, chip inductor, chip varistor, chip thermistor, chip resistor, and other surface mounted (SMD) chip type electronic devices may be mentioned.

According to the present invention, in the production method of an electronic device, such as a multilayer ceramic capacitor, an internal electrode thin film having a dielectric thin film and a metal thin film is formed as a pre-fired internal electrode thin film, the internal electrode thin films are stacked with green sheets to be dielectric layers after firing to form a multilayer body, and the multilayer body is fired; so that grain growth of metal particles at the firing step can be suppressed, spheroidizing of internal electrode layers and breaking of electrodes can be effectively prevented, and a decline of capacitance can be effectively suppressed.

### BRIEF DESCRIPTION OF DRAWINGS

These and other objects and features of the present invention will become clearer from the following description of the preferred embodiments given with reference to the attached drawings, in which:

FIG. 1 is a schematic sectional view of a multilayer ceramic capacitor according to an embodiment of the present invention;

FIG. 2 is a sectional view of a key part of a pre-fired internal electrode thin film according to a production method of the present invention;

FIG. 3A is a sectional view of a key part showing a method of forming the pre-fired internal electrode thin film of the present invention;

FIG. 3B is a sectional view of a key part showing a method of forming the pre-fired internal electrode thin film of the present invention;

FIG. 3C is a sectional view of a key part showing a method of forming the pre-fired internal electrode thin film of the present invention;

FIG. 4A is a sectional view of a key part showing a method of transferring the pre-fired internal electrode thin film;

FIG. 4B is a sectional view of a key part showing a method of transferring the pre-fired internal electrode thin film;

FIG. 4C is a sectional view of a key part showing a method of transferring the pre-fired internal electrode thin film;

FIG. 5A is a sectional view of a key part showing a method of transferring the pre-fired internal electrode thin film;

FIG. 5B is a sectional view of a key part showing a method of transferring the pre-fired internal electrode thin film;

FIG. 5C is a sectional view of a key part showing a method of transferring the pre-fired internal electrode thin film;

FIG. 6 is a sectional view of a key part of a pre-fired internal electrode thin film according to another embodiment of the present invention;

FIG. 7 is a sectional view of a key part of a pre-fired internal electrode thin film according to still another embodiment of the present invention

FIG. 8 is a sectional view of a key part of a multilayer body sample according to an example of the present invention;

FIG. 9A is a SEM picture of an internal electrode layer after firing according to an example of the present invention; and

FIG. 9B is a SEM picture of an internal electrode layer after firing according to a comparative example of the present invention.

### DESCRIPTION OF THE PREFERRED EMBODIMENT

Below, the present invention will be explained based on embodiments shown in drawings.

First, as one embodiment of electronic devices produced by the method of the present invention, an overall configuration of a multilayer ceramic capacitor will be explained.

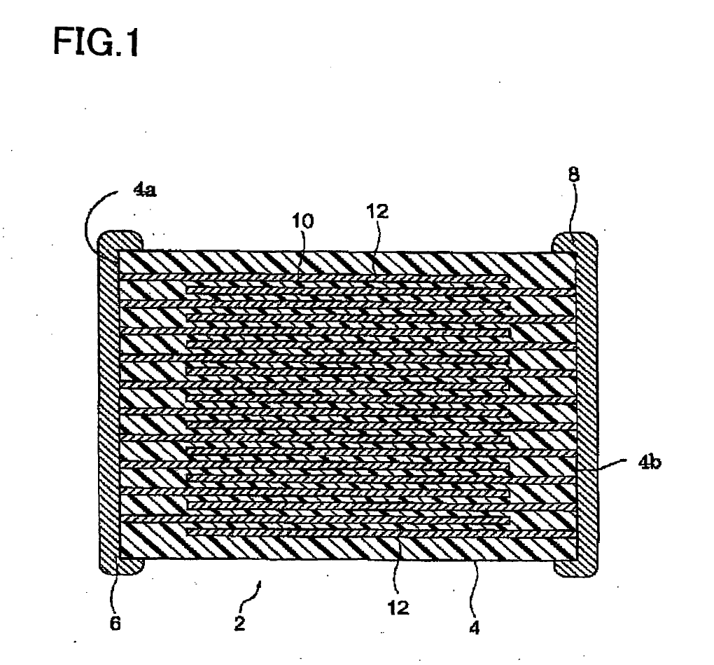

As shown in FIG. 1, a multilayer ceramic capacitor 2 according to the present embodiment comprises a capacitor element body 4, a first terminal electrode 6 and a second terminal electrode 8. The capacitor element body 4 comprises dielectric layers 10 and internal electrode layers 12, and the internal electrode layers 12 are alternately stacked between the dielectric layers 10. The alternately stacked internal electrode layers 12 on one side are electrically connected to inside of the first terminal electrode 6 formed outside of a first end portion 4a of the capacitor element body 4. Also, the alternately stacked internal electrode layers 12 on the other side are electrically connected to inside of the second terminal electrode 8 formed outside of a second end portion 4b of the capacitor element body 4.

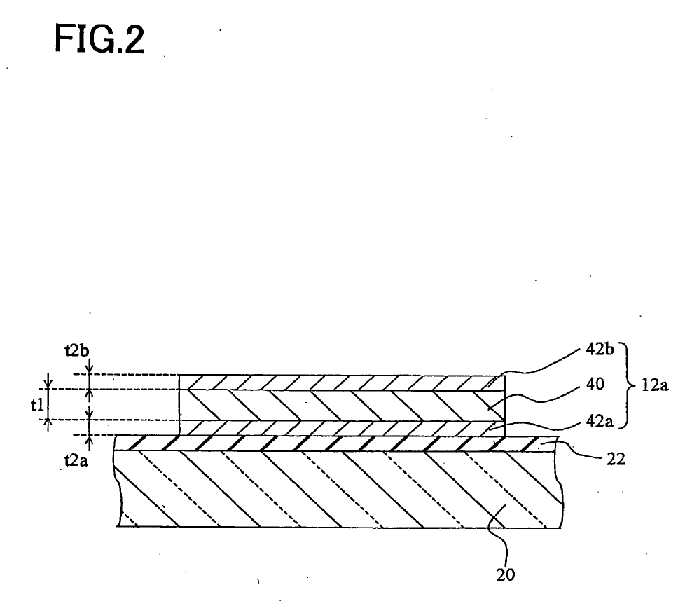

In the present embodiment, each of the internal electrode layers 12 is formed by firing a pre-fired internal electrode thin film 12a composed of dielectric thin films 42a and 42b and a metal thin film 40 shown in FIG. 2 as will be explained later on.

A material of the dielectric thin films 42a and 42b in the pre-fired internal electrode thin film is not particularly limited and, for example, BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₅, Lu₂O₃, CaTiO₃ and SrTiO₃, etc. can be preferably used.

Also, a material of the dielectric layers 10 is not particularly limited and it may be composed of dielectric materials, such as calcium titanate, strontium titanate and barium titanate. Among them, barium titanate is preferably used. Furthermore, the dielectric layers 10 may be added with a variety of subcomponents in accordance with need. A thickness of each dielectric layer 10 is not particularly limited but is generally several μm to hundreds of μm. Particularly in this embodiment, it is made as thin as preferably 5 μm or thinner, and more preferably 3 μm or thinner.

Also, a material of the terminal electrodes 6 and 8 is not particularly limited and copper, copper alloys, nickel and nickel alloys, etc. are normally used. Silver and an alloy of silver and palladium may be also used. A thickness of the terminal electrodes 6 and 8 is not particularly limited and is normally 10 to 50 μm or so.

A shape and size of the multilayer ceramic capacitor 2 may be suitably determined in accordance with the use object. When the multilayer ceramic capacitor 2 is a rectangular parallelepiped shape, it is normally a length (0.6 to 5.6 mm, preferably 0.6 to 3.2 mm)×width (0.3 to 5.0 mm, preferably 0.3 to 1.6 mm)×thickness (0.1 to 1.9 mm, preferably 0.3 to 1.6 mm) or so.

Next, an example of a production method of the multilayer ceramic capacitor 2 according to the present embodiment will be explained.

First, dielectric paste is prepared for producing a ceramic green sheet for composing the dielectric layers 10 shown in FIG. 1 after firing.

The dielectric paste is normally composed of organic solvent based paste obtained by kneading a dielectric material and an organic vehicle or water based paste.

The dielectric material may be suitably selected from composite oxides and a variety of compounds, which become oxides by firing, for example, carbonates, nitrites, hydroxides and organic metal compounds, etc. and mixed for use. The dielectric material is normally used as a powder having an average particle diameter of 0.1 to 3.0 μm or so. Note that, to form an extremely thin green sheet, it is preferable to use a finer powder than a thickness of the green sheet.

An organic vehicle is obtained by dissolving a binder in an organic solvent. The binder to be used for the organic vehicle is not particularly limited and may be suitably selected from a variety of normal binders, such as ethyl cellulose, polyvinyl butyral and an acrylic resin. Preferably, polyvinyl butyral or other butyral based resin is used.

Also, the organic solvent to be used for the organic vehicle is not particularly limited and an organic solvent, such as terpineol, butyl carbitol, acetone and toluene, is used. A vehicle in a water based paste is obtained by dissolving a water-soluble binder in water. The water-soluble binder is not particularly limited and polyvinyl alcohol, methyl cellulose, hydroxyl ethyl cellulose, water-soluble acrylic resin and emulsion, etc. may be used. A content of each component in the dielectric paste is not particularly limited and may be a normal content, for example, about 1 to 5 wt % of a binder and about 10 to 50 wt % of a solvent (or water).

The dielectric paste may contain additives selected from a variety of dispersants, plasticizers, dielectrics, glass frits and insulators, etc. in accordance with need. Note that a total content of them is preferably 10 wt % or smaller. When using a butyral based resin as the binder resin. It is preferable that a content of a plasticizer is 25 to 100 parts by weight with respect to 100 parts by weight of the binder resin. When the plasticizer is too small, the green sheet tends to become rattle, while when too large, the plasticizer exudes and the handleability becomes poor.

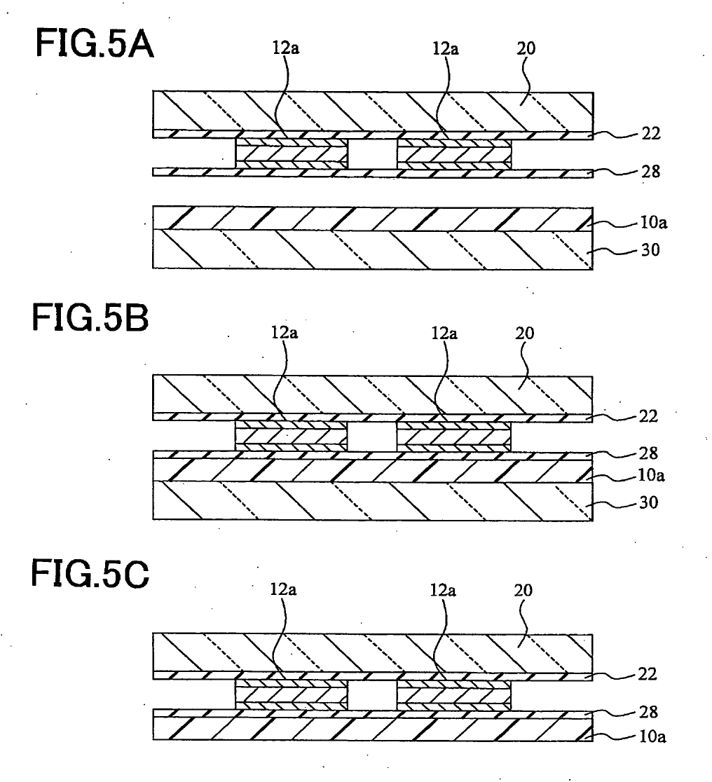

Next, by using the dielectric paste, a green sheet 10a is formed to be a thickness of preferably 0.5 to 30 μm and more preferably 0.5 to 10 μm or so on a carrier sheet 30 as a second support sheet as shown in FIG. 5A by the doctor blade method, etc. A temperature of drying the green sheet 10a is preferably 50 to 100° C. and the drying time is preferably 1 to 5 minutes.

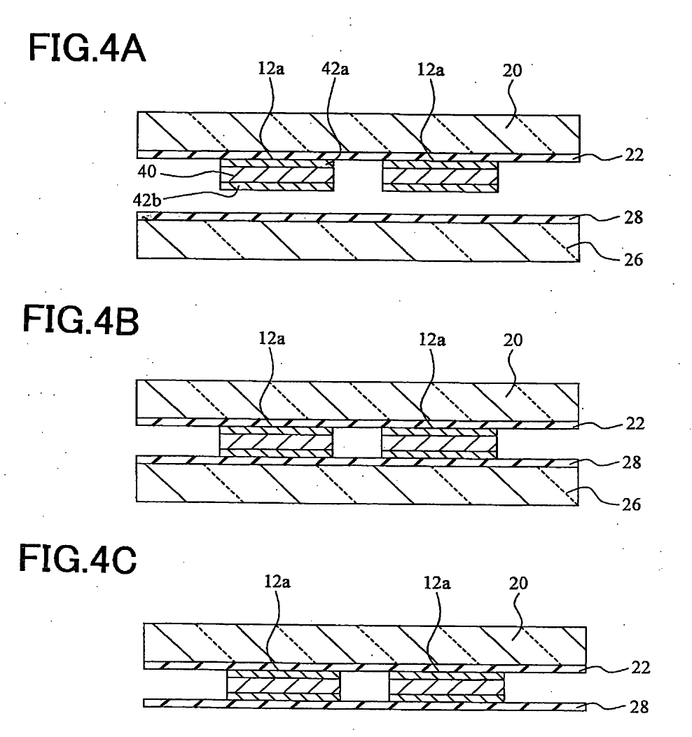

Next, as shown in FIG. 4A, a carrier sheet 20 as a first support sheet is prepared separately from the carrier sheet 30, and a release layer 22 is formed thereon. Then, on a surface of the release layer 22, a pre-fired internal electrode thin film 12a for composing an internal electrode layer 12 after firing is formed in a predetermined pattern.

For example, a PET film, etc. is used as the carrier sheets 20 and 30 and those coated with silicon, etc. are preferable to improve the releasing capability. Thicknesses of the carrier sheets 20 and 30 are not particularly limited, but 5 to 100 μm is preferable. The thicknesses of the carrier sheets 20 and 30 may be same or different.

The release layer 22 includes the same dielectric particles as the dielectric composing the green sheet 10a shown in FIG. 5A. Also, the release layer 22 includes a binder, a plasticizer and a releasing agent as an optional component in addition to the dielectric particles. A particle diameter of the dielectric particles may be the same as a particle diameter of the dielectric particles included in the green sheet, but it is preferably smaller. A method of forming the release layer 22 is not particularly limited but a method of applying by using a wire bar coater or a die coater is preferable because it has to be formed to be extremely thin.

The pre-fired internal electrode thin film 12a is composed of a metal thin film 40 and a pair of dielectric thin films 42a and 42b as shown in FIG. 2. The pair of dielectric thin films 42a and 42b are formed to sandwich the metal thin film 40, and the internal electrode thin film 12a has a three-layer structure.

The metal thin film 40 is a thin film including a material having conductivity, such as a metal material, as its main component. The conductive material to be included in the metal thin film 40 is not particularly limited and, for example when using a material having reduction resistance as a component of the dielectric layer 10, base metals may be used. As the base metals, metals including nickel as the main component or alloys of nickel with other metals are preferable. As nickel alloys, alloys of at least one kind of element selected from ruthenium (Ru), rhodium (Rh), rhenium (Re) and platinum (Pt) with nickel are preferable, and a nickel content in the alloys is preferably 87 mol % or larger. Note that the nickel alloys may include a variety of trace components, such as S, C and P, in an amount of about 0.1 wt % or smaller.

The dielectric thin films 42a and 42b are thin films including a dielectric material as their main component. As the dielectric material to be included in the dielectric thin films 42a and 42b, a variety of dielectric materials can be used and is not particularly limited; however, it is preferable to include a dielectric material having substantially the same composition as that contained in the release layer 22 and the green sheet 10a. As a result, adhesiveness of contact surfaces formed between the dielectric thin films 42a and 42b, the release layer 22 and the green sheet 10a can be furthermore improved.

A thickness (t1) of the metal thin film 40 in the internal electrode thin film is preferably 0.1 to 1.0 μm, and more preferably 0.1 to 0.5 μm. When the thickness (t1) of the metal thin films 40 is too thick, it is liable that attaining of a compact capacitor with a large capacity becomes difficult, while when too thin, it is liable that the effect of suppressing spheroidizing of the internal electrode layers and breaking of electrodes becomes insufficient.

A total thickness (t2: t2=t2a+t2b) of the dielectric thin films 42a and 42b in the internal electrode thin film 12a is preferably 0.02 μm to 0.2 μm. When a thickness (t2) of the dielectric thin films 42 is too thick, it is liable that breaking of electrodes in the internal electrode layer increases, while when too thin, it is liable that the effect of forming the dielectric thin film in the internal electrode thin film declines, spheroidizing of the internal electrode layer arises at the time of firing and breaking of electrodes increases. Note that a ratio of thicknesses (t2a/t2b) of the dielectric thin films 42a and 42b is not particularly limited, but the thicknesses are normally about the same.

Also, a ratio (t2/t1) of the thickness (t1) of the metal thin film 40 and the total thickness (t2) of the dielectric thin films 42a and 42b is preferably 0.05 to 1, more preferably 0.05 to 0.5. When the t2/t1 is too small, it is liable that the effect of forming the dielectric thin film in the internal electrode thin film decline, spheroidizing of the internal electrode layer arises at the time of firing and breaking of electrodes increases. On the other hand, when the t2/t1 is too large, a content of the dielectric material in the internal electrode thin film becomes too large comparing with that of the metal material, and breaking of electrodes in the internal electrode layer tends to increase.

As methods of forming the dielectric thin films 42a and 42b and metal thin film 40 composing the pre-fired internal electrode thin film 12a, the plating method, vapor deposition method, sputtering method and other thin film formation method may be mentioned.

For example, when forming the pre-fired internal electrode thin film 12a by the sputtering method, it is performed as below.

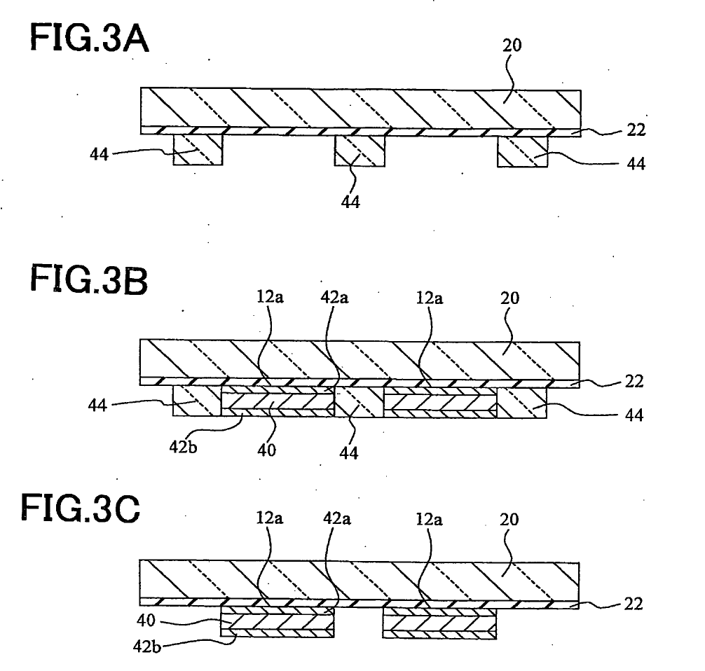

First, as shown in FIG. 3A, on a surface of the release layer 22 on the carrier sheet 20, a metal mask 44 having a predetermined pattern is formed as a shield mask. Next, sputtering is performed by using as sputtering target materials a metal thin film target for forming the dielectric thin films 42a and 42b and a metal thin film target for forming the metal thin film 40. As shown in FIG. 3B, three-layer film is formed on the release layer 22 in an order of the dielectric thin film 42a, metal film 40 and dielectric thin film 42b. Sputtering of these is performed successively in the same chamber, but may be performed in separate chambers.

As the dielectric thin film target for forming the dielectric thin films 42a and 42b, a variety of dielectric materials to be composing the dielectric thin films 42a and 42b, for example, composite oxides and a variety of compounds to be oxides by firing, etc. may be used. Specifically, BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃, etc. may be mentioned.

Also, as the metal thin film target for forming the metal thin film 40, a variety of metal materials to be composing the metal thin film 40 may be used and, for example, metals including nickel as the main component or alloys of nickel with other metals, etc. may be used.

As sputtering conditions, the ultimate vacuum is preferably 10⁻² Pa or lower and more preferably 10⁻³ Pa or lower, an output is preferably 50 to 400 W and more preferably 100 to 300 W, and a sputtering temperature is preferably 20 to 150° C. and more preferably 20 to 120° C. Also, as an atmosphere at sputtering, an Ar/O₂ gas or only an Ar gas is introduced when forming the dielectric thin films 42a and 42b and an Ar gas is introduced when forming the metal thin film 40 with a pressure of preferably 0.1 to 2 Pa, more preferably 0.3 to 0.8 Pa, respectively.

Thicknesses of the dielectric thin films 42a and 42b and the metal thin film 40 can be controlled by adjusting the respective sputtering conditions and film forming time.

Next, by removing the metal mask 44, the internal electrode thin film 12a composed of the dielectric thin films 42a and 42b and the metal thin film 40 having a predetermined pattern as shown in FIG. 3C can be formed on the release layer 22.

Next, separately from the carrier sheets 20 and 30, as shown in FIG. 4A, an adhesive layer transfer sheet is prepared, wherein an adhesive layer 28 is formed on a surface of a carrier sheet 26 as the third support sheet. The carrier sheet 26 is the same sheet as the carrier sheets 20 and 30. A composition of the adhesive layer 28 is the same as that of the release layer 22 except for not including any mold releasing agents. Namely, the adhesive layer 28 includes a binder, plasticizer and mold releasing agent. The adhesive layer 28 may include the same dielectric particles as those in the dielectric composing the green sheet 10a, but when forming a thin adhesive layer having a thinner thickness than a particle diameter of the dielectric particles, it is more preferable not to include the dielectric particles.

Next, to form the adhesive layer on a surface of the internal electrode thin film 12a shown in FIG. 4A, a transfer method is used in the present embodiment. Namely, as shown in FIG. 4B, the adhesive layer 28 of the carrier sheet 26 is pressed against the surface of the internal electrode layer 12a, heat and pressure are applied thereto, then, the carrier sheet 26t is removed, consequently, the adhesive layer 28 is transferred to the surface of the internal electrode thin film 12a as shown in FIG. 4C.

A heating temperature at that time is preferably 40 to 100° C., and the pressure force is preferably 0.2 to 15 MPa. The pressure may be applied by a press or by a calendar roll, but it is preferable to use a pair of rolls.

After that, the internal electrode thin film 12a is bonded with the surface of the green sheet 10a formed on the surface of the carrier sheet 30 shown in FIG. 5A. For that purpose, as shown in FIG. 5B, the internal electrode thin film 12a on the carrier sheet 20 is pressed against the surface of the green sheet 10a together with the carrier sheet 20 via the adhesive layer 28, heat and pressure are applied so as to transfer the internal electrode thin film 12a to the surface of the green sheet 10a as shown in FIG. 5C. Note that since the carrier sheet 30 on the green sheet side is peeled off, when seeing from the green sheet 10a side, the green sheet 10a is transferred to the internal electrode thin film 12a via the adhesive layer 28.

The heat and pressure at the transfer may be applied by a press or by a calendar roll, but it is preferable to use a pair of rolls. The heating temperature and pressure are the same as those in transferring the adhesive layer 28.

From the steps as above shown in FIG. 4A to FIG. 5C, the internal electrode thin film 12a having a predetermined pattern and composed of the dielectric thin films 42a and 42b and the metal thin film 40 is formed on one green sheet 10a. By using the result, a multilayer body, wherein a large number of the internal electrode thin films 12a and the green sheets 10a are alternately stacked, is obtained.

Then, after finally pressuring the multilayer body, the carrier sheet 20 is peeled off. A pressure at the final pressuring is preferably 10 to 200 MPa. Also, the heating temperature is preferably 40 to 100° C. After that, the multilayer body is cut to be a predetermine size to form a green chip. Then, the green chip is subjected to binder removal processing and firing.

The binder removal processing is preferably performed in the air or in N₂ of a binder removal atmosphere when nickel as a base metal is used for the metal thin film of the internal electrode layer as in the present invention. Also, as other binder removal conditions, the temperature raising rate is preferably 5 to 300° C./hour and more preferably 10 to 50° C./hour, the holding temperature is preferably 200 to 400° C. and more preferably 250 to 350° C., and the temperature holding time is preferably 0.5 to 20 hours and more preferably 1 to 10 hours.

Firing of the green chip is preferably performed in an atmosphere under an oxygen partial pressure of 10⁻¹⁰ to 10⁻² Pa and more preferably 10⁻¹⁰ to 10⁻⁵ Pa. When the oxygen partial pressure at the firing is too low, the metal material in the internal electrode layer may result in abnormal sintering to be broken, while when too high, the internal electrode layer tends to be oxidized.

Firing of the green chip is performed at a low temperature of 1300° C. or lower, more preferably 1000 to 1300° C., and particularly preferably 1150 to 1250° C. When the firing temperature is too low, the green chip is not densified, while when too high, breaking of electrodes in the internal electrode layer is caused and the dielectric is reduced.

As other firing conditions, the temperature raising rate is preferably 50 to 500° C./hour and more preferably 200 to 300° C./hour, the temperature holding time is preferably 0.5 to 8 hours and more preferably 1 to 3 hours, and the cooling rate is preferably 50 to 500° C./hour and more preferably 200 to 300° C./hour. The firing atmosphere is preferably a reducing atmosphere, and a mixed gas of N₂ and H₂ in a wet state is preferably used as the atmosphere gas.

Next, annealing is performed on the fired capacitor chip body. Annealing is processing for re-oxidizing the dielectric layers, and an accelerated lifetime of insulation resistance (IR) can be remarkably elongated and reliability improves by that.

Annealing of the fired capacitor chip body is preferably performed under a higher oxygen partial pressure than that of the reducing atmosphere at the time of firing, specifically, the oxygen partial pressure of the atmosphere is preferably 10⁻² to 100 Pa, and more preferably 10⁻² to 10 Pa. When the oxygen partial pressure at annealing is too low, re-oxidizing of the dielectric layers 10 becomes difficult, while when too high, the internal electrode layers 12 tend to be oxidized.

In the present embodiment, the holding temperature or the highest temperature at annealing is preferably 1200° C. or lower, more preferably 900 to 1150° C., and particularly preferably 1000 to 1100° C. Also, in the present invention, the holding time of the temperature is preferably 0.5 to 4 hours and more preferably 1 to 3 hours. When the holding temperature or the highest temperature at annealing is lower than the above ranges, oxidization of the dielectric material becomes insufficient and the insulation resistance lifetime tends to become short, while when it is higher than the above ranges, it is liable that nickel in the internal electrode layers is oxidized and not only declining the capacity but it reacts with the dielectric base and the lifetime also becomes short. Note that the annealing may be composed only of the temperature raising step and the temperature lowering step. Namely, the temperature holding time may be zero. In that case, the holding temperature is the highest temperature.

As other annealing conditions, the cooling rate is preferably 50 to 500° C./hour and more preferably 100 to 300° C./hour. As the atmosphere gas at annealing, for example, a wet N₂ gas, etc. is preferably used.

Note that to wet the N₂ gas, for example, a wetter, etc. is used. In that case, the water temperature is preferably 0 to 75° C. or so.

The binder removal processing, firing and annealing may be performed continuously or separately. When performing continuously, the atmosphere is changed without cooling after the binder removal processing continuously, the temperature is raised to the holding temperature at firing to perform firing. Next, it is cooled and the annealing is preferably performed by changing the atmosphere when the temperature reaches to the holding temperature of the annealing. On the other hand, when performing them separately, at the time of firing, after raising the temperature to the holding temperature of the binder removal processing in an atmosphere of a nitrogen gas or a wet nitrogen gas, the atmosphere is changed, and the temperature is preferably furthermore raised. After that, after cooling the temperature to the holding temperature of the annealing, it is preferable that the cooling continues by changing the atmosphere again to a N₂ gas or a wet N₂ gas. Also, in the annealing, after raising the temperature to the holding temperature under the N₂ gas atmosphere, the atmosphere may be changed, or the entire process of the annealing may be in a wet N₂ gas atmosphere.

End surface polishing, for example, by barrel polishing or sand blast, etc. is performed on the sintered body (element body 4) obtained as above, and the external electrode paste is burnt to form external electrodes 6 and 8. A firing condition of the external electrode paste is preferably, for example, at 600 to 800° C. in a wet mixed gas of N₂ and H₂ for 10 minutes to 1 hour or so. A pad layer is formed by plating, etc. on the surface of the external electrodes 6 and 8 if necessary. Note that the terminal electrode paste may be fabricated in the same way as the electrode paste explained above.

A multilayer ceramic capacitor of the present invention produced as above is mounted on a print substrate, etc. by soldering, etc. and used for a variety of electronic apparatuses, etc.

In the present embodiment, an internal electrode thin film 12a having the dielectric thin films 42a and 42b and the metal thin film 40 is formed as the pre-fired internal electrode thin film 12a for composing the internal electrode layer 12 after firing. Therefore, spheroidizing of the internal electrode layers and breaking of electrodes caused by a difference of sintering temperatures between the dielectric material and metal material in the case of making the fired internal electrode layers 12 thinner, which have been notable disadvantages in the related arts, are prevented and a decline of the capacitance can be effectively suppressed.

Also, in the present embodiment, the pre-fired internal electrode thin film 12a is made to have a three-layer structure, wherein the metal thin film 40 is sandwiched by a pair of dielectric thin films 42a and 42b as shown in FIG. 2. Therefore, the dielectric thin films 42a and 42b and the green sheet 10a both including dielectric as their main components directly contact to form contact surfaces, so that adhesiveness of the contact surfaces can be improved and the effects of the present invention can be enhanced. Particularly, delamination of the internal electrode layers and dielectric layers after firing can be effectively prevented.

Furthermore, in the present embodiment, since the dielectric thin films 42a and 42b and the metal thin film 40 are formed by the thin film formation method, the dielectric thin films 42a and 42b and the metal thin film 40 can be bonded closely, adhesiveness of the thin films can be improved and, furthermore, arising of a clearance on the contact surfaces of the thin films can be effectively prevented. Note that the sputtering method, vapor deposition method and composite plating method, etc. can be mentioned as the thin film formation method, and the sputtering method is preferably used.

An embodiment of the present invention was explained above, however, the present invention is not limited to the embodiment and a variety of modifications may be naturally made within the scope of the present invention.

For example, in the above embodiment, a multilayer ceramic capacitor was explained as an example of an electronic device according to the present invention, however, the electronic device according to the present invention is not limited to multilayer ceramic capacitors and the present invention can be applied to other electronic devices.

Also, in the above embodiment, the pre-fired internal electrode thin film 12a was made to have the three-layer structure composed of the dielectric thin films 42a and 42b and the metal thin film 40, however, the internal electrode thin film 12a may have a two-layer structure composed of one dielectric thin film and one metal thin film.

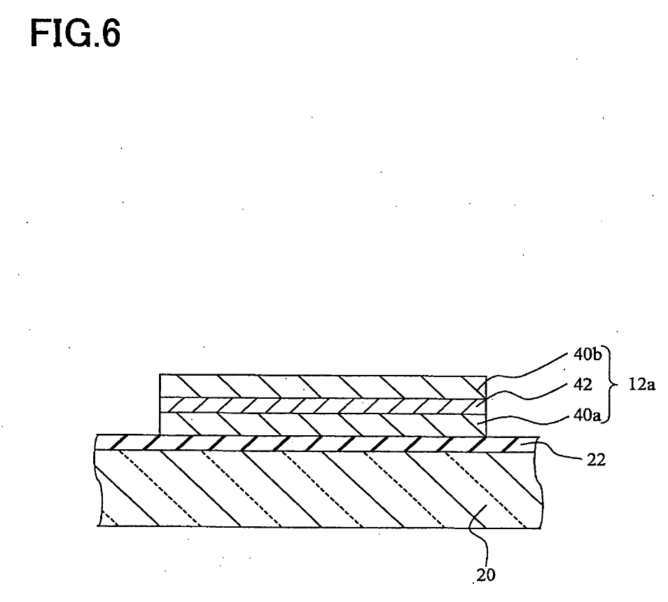

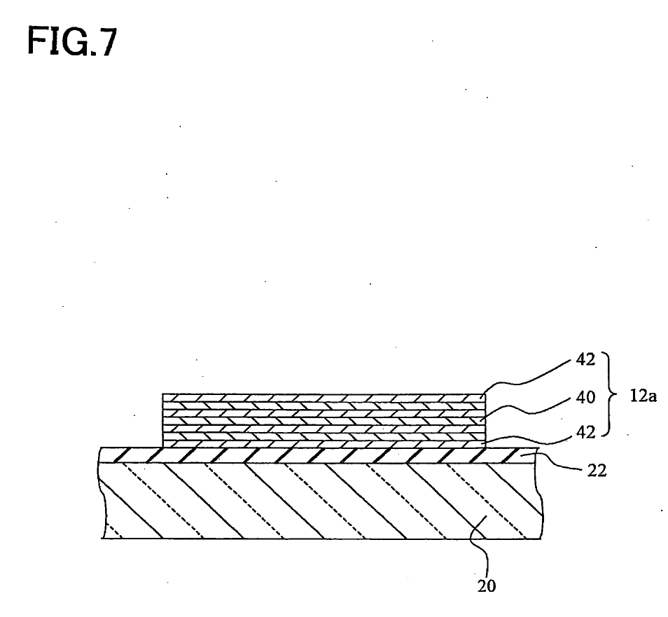

Also, as shown in FIG. 6, the pre-fired internal electrode thin film 12a may be made to have a three-layer structure, wherein the dielectric thin film 42 is sandwiched between a pair of metal thin films 40a and 40b. Alternately, the pre-fired internal electrode thin film 12a may be a multilayer body of a large number of layers formed by alternately stacking a plurality of metal thin films 40 and a plurality of dielectric thin films 42 as shown in FIG. 7. Note that, in FIG. 7, the pre-fired internal electrode thin film 12a is a multilayer body having seven layers in total including three metal thin films 40 and four dielectric thin films 42.

Also, in the above embodiment, the metal thin film 40 in the pre-fired internal electrode thin film 12a was formed by the thin film formation method, but it may be formed by the printing method for printing conductive paste including a metal material in a predetermined pattern.

Also, before the step of forming the adhesive layer 28 on the surface of the pre-fired internal electrode thin film 12a, a blank pattern layer having substantially the same thickness as that of the internal electrode thin film 12a and composed of substantially the same material as the green sheet 10a may be formed on the surface of the release layer 22, on which the internal electrode thin film 12a is not formed.

### EXAMPLES

Below, the present invention will be explained based on furthermore detailed examples, but the present invention is not limited to these examples.

### Example 1

### Production of Respective Paste

First, a BaTiO₃ powder (BT-02 made by Sakai Chemical Industry Co., Ltd.), MgCO₃, MnCO₃, (Ba_{0.6}Ca_{0.4})SiO₃ and a powder selected from rare earths (Gd₂O₃, Tb₄O₇, Dy₂O₃, Ho₂O₃, Er₂O₃, Tm₂O₃, Yb₂O₃, Lu₂O₃ and Y₂O₃) were wet mixed by a ball mill for 16 hours and dried to obtain a dielectric material. An average particle diameter of these material powders was 0.1 to 1 μm. The (Ba_{0.6}Ca_{0.4})SiO₃ was produced by wet mixing BaCO₃, CaCO₃ and SiO₂ by a ball mill for 16 hours, drying, then, firing at 1150° C. in the air, and dry pulverizing the result by a ball mill for 100 hours.

To make the obtained dielectric material to be paste, an organic vehicle was added to the dielectric material and mixed by a ball mill, so that dielectric green sheet paste was obtained. The organic vehicle has a compounding ratio of polyvinyl butyral as a binder in an 6 amount of 6 parts by weight, bis(2-ethylhexyl) phthalate (DOP) as a plasticizer in an amount of 3 parts by weight, ethyl acetate in an amount of 55 parts by weight, toluene in an amount of 10 parts by weight and paraffin as a releasing agent in an amount of 0.5 part by weight with respect to 100 parts by weight of the dielectric material.

Next, the dielectric green sheet paste was diluted two times in a weight ratio with ethanol/toluene (55/10) to obtain release layer paste.

Then, the same dielectric green sheet paste except for not including dielectric particles and releasing agent was diluted four times in a weight ratio with toluene to obtain adhesive layer paste.

Formation of Green Sheet 10a

First, the dielectric green sheet paste was applied to a PET film (second support sheet) by using a wire bar coater and, then, dried to form a green sheet having a thickness of 1.0 μm.

Formation of Pre-Fired Internal Electrode Thin Film 12a

The release layer paste is applied on another PET film (first support sheet) by using a wire bar coater and, then, dried to form a release layer having a thickness of 0.3 μm.

Next, on a surface of the release layer, the pre-fired internal electrode thin film 12a composed of the dielectric thin films 42a and 42b and metal thin film 40 as shown in FIG. 2 and having a predetermined thickness (refer to Table 1) was formed by the sputtering method by using a metal mask having a predetermined pattern for forming an internal electrode thin film 12a. In this example, thicknesses of the dielectric thin films 42a and 42b and metal thin film 40 were controlled by adjusting the film forming time. Note that the dielectric thin films 42a and 42b were not formed in Sample 1.

When sputtering, BaTiO₃ was used as a dielectric thin film target for forming the dielectric thin films 42a and 42b, and Ni was used as a metal thin film target for forming the metal thin film 40. As the BaTiO₃ and Ni targets, sputtering targets obtained by being cut into a shape having a diameter of about 4 inches and a thickness of 3 mm were used.

As other sputtering conditions, the ultimate vacuum was 10⁻³ Pa or lower, the output was 200 W and the temperature was at the room temperature (20° C.). As an atmosphere at sputtering, an Ar/O₂ gas was introduced when forming the dielectric thin films 42a and 42b and an Ar gas was introduced when forming the metal thin film 40 respectively under a pressure of 0.5 Pa.

Thicknesses of the dielectric thin films 42a and 42b and metal thin film 40 formed by sputtering were measured by forming films by sputtering also on a glass substrate when forming the dielectric thin films 42a and 42b and metal thin film 40, breaking the glass substrate having the thin films formed thereon, and performing SEM observation on the broken section.

Formation of Adhesive Layer

The adhesive layer paste explained above was applied to another PET film (third support sheet) by using a wire bar coater and, then, dried to form an adhesive layer having a thickness of 0.2 μm.

Note that, in this example, a PET film having surfaces subjected to release processing by a silicon based resin was used for all of the PET films (the first support sheet, second support sheet and third support sheet).

Formation of Final Multilayer Body (Pre-Fired Element Body)

First, the adhesive layer 28 was transferred to a surface of the internal electrode thin film 12a by the method shown in FIG. 4. At transferring, a pair of rolls were used, the pressure was 1 MPa and the temperature was

Next, the internal electrode thin film 12a was bonded (transferred) to a surface of the green sheet 10a via the adhesive layer 28 by the method shown in FIG. 5. At transferring, a pair of rolls were used, the pressure was 1 MPa and the temperature was 80° C.

Next, the internal electrode thin films 12a and green sheets 10a were stacked successively and, finally, a final multilayer body was obtained, wherein 21 layers of internal electrode thin films 12a were stacked. A stacking condition was a pressure of 50 MPa and a temperature of 120° C.

Production of Sintered Body

Next, the final multilayer body was cut to be a predetermined size and subjected to binder removal processing, firing and annealing (thermal treatment), so that a sintered body in a chip shape was produced.

The binder removal processing was performed as below.

Temperature raising rate: 15 to 50° C./hour

Holding temperature: 400° C.

Holding time: 2 hours

Atmosphere gas: wet N₂ gas

The firing was performed as below.

Temperature raising rate: 200 to 300° C./hour

Holding temperature: 1200° C.

Holding time: 2 hours

Cooling rate: 300° C./hour

Atmosphere gas: wet mixed gas of N₂+H₂

Oxygen partial pressure: 10⁻⁷ Pa

The annealing (re-oxidization) was performed as below.

Temperature raising rate: 200 to 300° C./hour

Holding temperature: 1050° C.

Temperature holding time: 2 hours

Cooling rate: 300° C./hour

Atmosphere gas: wet N₂ gas

Oxygen partial pressure: 10⁻² Pa

### Note that a wetter with a water temperature of 0 to 75° C. was used to wet the atmosphere gases at the time of binder removal, firing and annealing.

Next, end surfaces of the chip-shaped sintered body was polished by sand blast, then, an external electrode paste was transferred to the end surfaces and fired at 800° C. for 10 minutes in a wet N₂+H₂ atmosphere to form external electrodes, so that a multilayer capacitor sample having the configuration shown in FIG. 1 was obtained.

A size of each of the thus obtained samples was 3.2 mm×1.6 mm×0.6 mm, the number of dielectric layers sandwiched by the internal electrode layers was 21, a thickness thereof was 1 μm, and a thickness of the internal electrode layer was 0.5 μm. Electric characteristics (capacitance C and dielectric loss tan δ) were evaluated on each sample. The results are shown in Table 1. The electric characteristics (capacitance C and dielectric loss tan δ) were evaluated as below.

The capacitance C (unit: μF) was measured by a digital LCR meter (4274A made by YHP) at a reference temperature of 25° C. under conditions that a frequency was 1 kHz and an input signal level (measurement voltage) was 1Vrms. Capacitance C of 0.9 μF or higher was evaluated good.

The dielectric loss tan δ was measured by using a digital LCR meter (4274A made by YHP) at a reference temperature of 25° C. under conditions that a frequency was 1 kHz and an input signal level (measurement voltage) was 1Vrms. Dielectric loss tan δ of less than 0.1 was evaluated good.

Note that the characteristic values were obtained from an average value of values measured by using the number of samples n=10. In Table 1, “o” in the evaluation standard column indicates that preferable results were exhibited in all of the above characteristics, and “x” indicates that one or more results were not preferable among those.

TABLE 1
Table 1

| | | | | | Total Thickness | | | | |
|---|---|---|---|---|---|---|---|---|---|
| | | Thickness t1 of | Thickness t2a | Thickness t2b | t2 of Dielectric | | | | |
| | | Metal Thin Film | of Dielectric | of Dielectric | Thin Films 42a | | | | |
| Sample | | 40 | Thin Film 42a | Thin Film 42b | and 42b | | Capacitance | | |
| No. | | [μm] | [μm] | [μm] | [μm] | t2/t1 | [μF] | tan δ | Evaluation |
| 1 | Comparative | 0.4 | 0 | 0 | 0 | 0 | 0.83 | 0.01 | X |
| | Example | | | | | | | | |
| 2 | Example | 0.4 | 0.01 | 0.01 | 0.02 | 0.05 | 0.97 | 0.01 | ◯ |
| 3 | Example | 0.4 | 0.05 | 0.05 | 0.1 | 0.25 | 1.09 | 0.02 | ◯ |
| 4 | Example | 0.4 | 0.1 | 0.1 | 0.2 | 0.5 | 1.00 | 0.03 | ◯ |
| 5 | Reference | 0.4 | 0.2 | 0.2 | 0.4 | 1 | 0.76 | 0.03 | X |
| | Example | | | | | | | | |

As shown in Table 1, the samples 2 to 4 as examples, wherein a thickness t1 of the metal thin films 40 was 0.4 μm and thicknesses t2a and t2b of the dielectric thin films 42a and 42b were respectively 0.01 to 0.1 μm, that is, a total thickness t2 (t2=t2a+t2b) of the dielectric thin films 42a and 42b was 0.02 to 0.2 μm, capacitance became 0.9 μF or higher and the dielectric loss tan δ was less than 0.1 in all samples, which were preferable results. Note that t2/t1 was 0.05 to 0.5 in the samples 2 to 4 as examples.

On the other hand, a sample 1 as a comparative example, wherein the dielectric thin films 42a and 42b were not formed, exhibited results that spheroidizing of internal electrode layers arose, breaking of electrodes arose, and the capacitance became as low as 0.83 μF.

Also, a sample 5 as a reference example, wherein a thickness t1 of the metal thin films 40 was 0.4 μm and thicknesses t2a and t2b of the dielectric thin films 42a and 42b were respectively 0.2 μm, exhibited results that breaking of electrodes arose in the internal electrode layers and the capacitance became as low as 0.76 μF. Note that t2/t1 in the sample 5 as reference example was 1.

From the results, it was confirmed that by forming the internal electrode thin film 12a having the dielectric thin films 42a and 42b and metal thin film 40 as the pre-fired internal electrode thin film 12a, spheroidizing of internal electrode layers and breaking of electrodes can be prevented even when internal electrode layers after firing are made thinner and a decline of capacitance can be suppressed. Also, it was confirmed that by setting the thickness t1 of the metal thin film 40, the total thickness t2 of the dielectric thin films 42a and 42b, and a ratio (t2/t1) of the two to be in the preferable ranges of the present invention, particularly, the effects of the present invention were obtained.

### Example 2

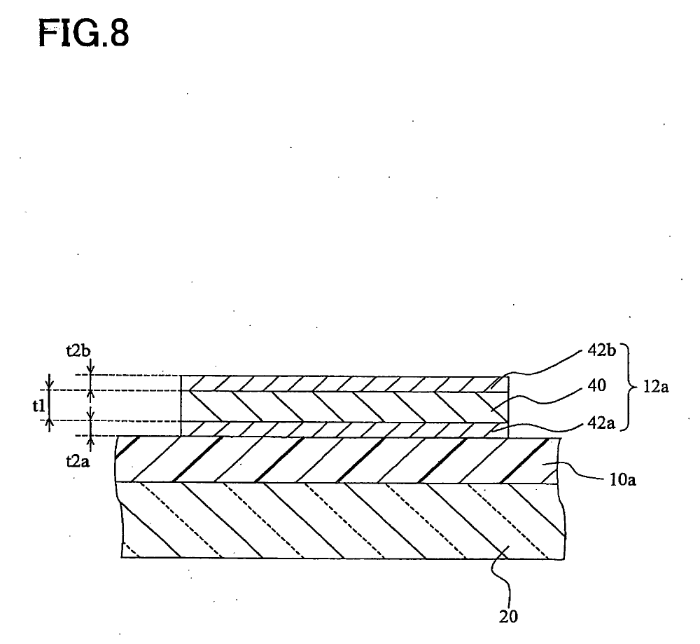

The dielectric green sheet paste produced in the example 1 was applied to the PET film (carrier sheet) by using a wire bar coater and, then, dried to obtain a green sheet 10a. A pre-fired internal electrode thin film 12a was formed on the green sheet 10a in the same way as in the example 1 and a multilayer body as shown in FIG. 8 was produced. Next, the PET film was removed from the multilayer body to produce a pre-fired sample composed of the green sheet 10a and the internal electrode thin film 12a. The pre-fired sample was subjected to binder removal, firing and annealing in the same way as in the example 1, so that a sample for surface observation after firing composed of the dielectric layers 10 and the internal electrode layers 12 was produced.

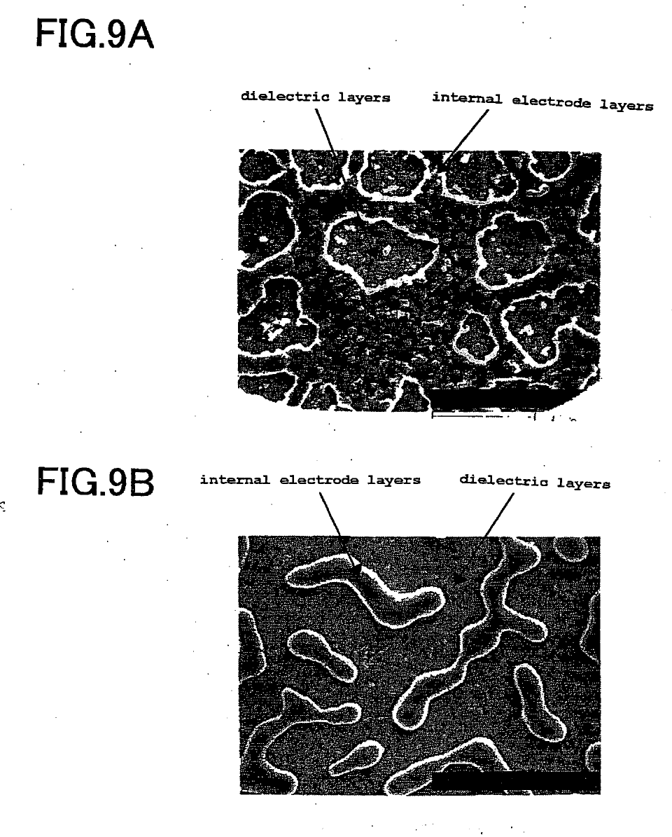

Next, SEM observation was made on the obtained surface observation sample from the vertical direction with respect to the surface formed with the internal electrode layer 12, and the fired internal electrode layer was observed and evaluated. Obtained SEM pictures are shown in FIG. 9A and FIG. 9B. FIG. 9A corresponds to the sample 3 in the example 1, and FIG. 9B corresponds to the sample 1 in the example 1. Namely, FIG. 9A and FIG. 9B are SEM pictures of samples, wherein internal electrode thin film was formed under the same condition as that in the respective capacitor samples in the example 1.

FIG. 9A is a SEM picture of a sample, wherein a thickness t1 of the metal thin films 40 was 0.4 μm and a total thickness t2 of the dielectric thin films 42a and 42b was 0.1 μm, and as is obvious from the picture, breaking of the internal electrode layers (white parts in the SEM picture) is not observed and a preferable result was obtained.

On the other hand, from FIG. 9B, the sample, 6 wherein the dielectric thin films 42a and 42b were not formed, exhibited results that spheroidizing of nickel arose and breaking of electrodes became notable. Particularly, by comparing FIG. 9A and FIG. 9B, it can be confirmed that spheroidizing of nickel can be suppressed and breaking of internal electrodes can be effectively prevented by forming the dielectric thin films 42a and 42b.

### Example 3

Other than using MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂%, Er₂O₃, Tm₂O₃, Yb₂O₃, Lu₂O₃, CaTiO₃ or SrTiO₃ instead of BaTiO₃ as a dielectric thin film target for forming the dielectric thin films 42a and 42b when sputtering, samples were obtained in the same way as in the example 1. Note that a thickness t1 of the metal thin films 40 in each of the samples was 0.4 μm and thicknesses t2a and t2b of the dielectric thin films 42a and 42b were respectively 0.05 μm, that is, a total thickness t2 (t2=t2a+t2b) of the dielectric thin films 42a and 42b was 0.1 μm. Evaluation of electric characteristics (capacitance C and dielectric loss tan δ) was made on each sample in the same way as in the example 1. The results are shown in Table 2.

TABLE 2
Table 2

| | | Composition | Thickness t1 of | Thickness t2a | Thickness t2b | Total Thickness | | | | |
|---|---|---|---|---|---|---|---|---|---|---|
| | | of Dielectric | Metal Thin Film | of Dielectric | of Dielectric | t2 of Dielectric | | | | |
| Sample | | Thin Films | 40 | Thin Film 42a | Thin Film 42b | Thin Films 42a | | Capacitance | | |
| No. | | 42a and 42b | [μm] | [μm] | [μm] | and 42b | t2/t1 | [μF] | tan δ | Evaluation |
| 6 | Example | MgO | 0.4 | 0.05 | 0.05 | 0.1 | 0.25 | 1.05 | 0.01 | ◯ |
| 7 | Example | Al2O3 | 0.4 | 0.05 | 0.05 | 0.1 | 0.25 | 1.06 | 0.01 | ◯ |
| 8 | Example | SiO2 | 0.4 | 0.05 | 0.05 | 0.1 | 0.25 | 1.05 | 0.01 | ◯ |
| 9 | Example | CaO | 0.4 | 0.05 | 0.05 | 0.1 | 0.25 | 1.05 | 0.01 | ◯ |
| 10 | Example | TiO2 | 0.4 | 0.05 | 0.05 | 0.1 | 0.25 | 1.07 | 0.01 | ◯ |
| 11 | Example | V2O3 | 0.4 | 0.05 | 0.05 | 0.1 | 0.25 | 1.05 | 0.01 | ◯ |
| 12 | Example | MnO | 0.4 | 0.05 | 0.05 | 0.1 | 0.25 | 1.07 | 0.01 | ◯ |
| 13 | Example | SrO | 0.4 | 0.05 | 0.05 | 0.1 | 0.25 | 1.05 | 0.01 | ◯ |
| 14 | Example | Y2O3 | 0.4 | 0.05 | 0.05 | 0.1 | 0.25 | 1.07 | 0.01 | ◯ |
| 15 | Example | ZrO2 | 0.4 | 0.05 | 0.05 | 0.1 | 0.25 | 1.07 | 0.01 | ◯ |
| 16 | Example | Nb2O5 | 0.4 | 0.05 | 0.05 | 0.1 | 0.25 | 1.05 | 0.01 | ◯ |
| 17 | Example | BaO | 0.4 | 0.05 | 0.05 | 0.1 | 0.25 | 1.05 | 0.01 | ◯ |
| 18 | Example | HfO2 | 0.4 | 0.05 | 0.05 | 0.1 | 0.25 | 1.04 | 0.01 | ◯ |
| 19 | Example | La2O3 | 0.4 | 0.05 | 0.05 | 0.1 | 0.25 | 1.06 | 0.01 | ◯ |
| 20 | Example | Gd2O3 | 0.4 | 0.05 | 0.05 | 0.1 | 0.25 | 1.06 | 0.01 | ◯ |
| 21 | Example | Tb4O7 | 0.4 | 0.05 | 0.05 | 0.1 | 0.25 | 1.06 | 0.01 | ◯ |
| 22 | Example | Dy2O3 | 0.4 | 0.05 | 0.05 | 0.1 | 0.25 | 1.06 | 0.01 | ◯ |
| 23 | Example | Ho2O3 | 0.4 | 0.05 | 0.05 | 0.1 | 0.25 | 1.05 | 0.01 | ◯ |
| 24 | Example | Er2O3 | 0.4 | 0.05 | 0.05 | 0.1 | 0.25 | 1.06 | 0.01 | ◯ |
| 25 | Example | Tm2O3 | 0.4 | 0.05 | 0.05 | 0.1 | 0.25 | 1.06 | 0.01 | ◯ |
| 26 | Example | Yb2O3 | 0.4 | 0.05 | 0.05 | 0.1 | 0.25 | 1.05 | 0.01 | ◯ |
| 27 | Example | Lu2O3 | 0.4 | 0.05 | 0.05 | 0.1 | 0.25 | 1.07 | 0.01 | ◯ |
| 28 | Example | CaTiO3 | 0.4 | 0.05 | 0.05 | 0.1 | 0.25 | 1.07 | 0.01 | ◯ |
| 29 | Example | SrTiO3 | 0.4 | 0.05 | 0.05 | 0.1 | 0.25 | 1.07 | 0.01 | ◯ |

As shown in Table 2, all of samples 6 to 29 in this example exhibited preferable results that the capacitance became 1.04 μF or higher and the dielectric loss tan δ became 0.01.

From the results, it was confirmed that by using at least one kind of MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃ other than BaTiO₃ as a dielectric thin film target for forming the dielectric thin films 42a and 42b, spheroidizing of the internal electrode layers, breaking of electrodes can be prevented and a decline of the capacitance can be suppressed even when the internal electrodes after firing were made thinner. From the results, also when using other dielectric components than BaTiO₃, by setting a ratio (t2/t1) of the total thickness t2 of the dielectric thin films 42a and 42b and the thickness t1 of the metal thin film 40 to be in a preferable range of the present invention, the same effects as those in the case of using BaTiO₃ are expected to be obtained.

### Example 4

Other than not forming the dielectric thin film 42b when forming the pre-fired internal electrode thin film 12a, samples were obtained in the same way as in the example 1. Samples 30 and 31 were obtained, wherein a thickness t1 of the metal thin film 40 in each of the samples was 0.4 μm and a thickness t2a of the dielectric thin film 42a was 0.05 or 0.1 μm, that is, a total thickness t2 (t2=t2a+t2b) of the dielectric thin films 42a and 42b was 0.05 or 0.1 μm. Evaluation of electric characteristics (capacitance C and dielectric loss tan δ) was made on each sample in the same way as in the example 1. The results are shown in Table 3.

### Example 5

Other than not forming the dielectric thin film 42a when forming the pre-fired internal electrode thin film 12a, samples were obtained in the same way as in the example 1. Samples 32 and 33 were obtained, wherein a thickness t1 of the metal thin film 40 in each of the samples was 0.4 μm and a thickness t2b of the dielectric thin film 42b was 0.05 or 0.1 μm, that is, a total thickness t2 (t2=t2a+t2b) of the dielectric thin films 42a and 42b was 0.05 or 0.1 μm. Evaluation of electric characteristics (capacitance C and dielectric loss tan δ) was made on each sample in the same way as in the example 1. The results are shown in Table 3.

TABLE 3
Table 3

| | | | | | Total Thickness | | | | |
|---|---|---|---|---|---|---|---|---|---|
| | | Thickness t1 of | Thickness t2a | Thickness t2b | t2 of Dielectric | | | | |
| | | Metal Thin Film | of Dielectric | of Dielectric | Thin Films 42a | | | | |
| Sample | | 40 | Thin Film 42a | Thin Film 42b | and 42b | | Capacitance | | |
| No. | | [μm] | [μm] | [μm] | [μm] | t2/t1 | [μF] | tan δ | Evaluation |
| 30 | Example | 0.4 | 0.05 | 0 | 0.05 | 0.125 | 0.93 | 0.02 | ◯ |
| 31 | Example | 0.4 | 0.1 | 0 | 0.1 | 0.25 | 0.95 | 0.02 | ◯ |
| 32 | Example | 0.4 | 0 | 0.05 | 0.05 | 0.125 | 0.93 | 0.02 | ◯ |
| 33 | Example | 0.4 | 0 | 0.1 | 0.1 | 0.25 | 0.95 | 0.02 | ◯ |

As shown in Table 3, all of samples 30 to 33 in this example exhibited preferable results that the capacitance became 0.93 μF or higher and the dielectric loss tan δ all became 0.02.

From the results, it was confirmed that it was sufficient if at least one layer of the dielectric thin film and one layer of the metal thin film were included in the pre-fired internal electrode thin film.

1. A production method of an electronic device for producing an electronic device including internal electrode layers and dielectric layers, comprising the steps of:
forming a pre-fired internal electrode thin film having a dielectric thin film and a metal thin film;
stacking a green sheet to be a dielectric layer after firing and said internal electrode thin film; and
firing a multilayer body of said green sheet and said internal electrode thin film.

2. The production method of an electronic device as set forth in claim 1, wherein:
said dielectric thin film in said pre-fired internal electrode thin film includes at least one kind of BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃.

3. The production method of an electronic device as set forth in claim 1, wherein said pre-fired internal electrode thin film has a multilayer structure of two or more layers including at least one layer of said dielectric thin film and one layer of said metal thin film.

4. The production method of an electronic device as set forth in claim 1, wherein said metal thin film is sandwiched between a pair of said dielectric thin films and each of said pre-fired internal electrode thin films has a multilayer structure of three or more layers.

5. The production method of an electronic device as set forth in claim 1, wherein said dielectric thin film is sandwiched between a pair of said metal thin films and each of said pre-fired internal electrode thin films has a multilayer structure of three or more layers.

6. The production method of an electronic device as set forth in claim 1, wherein said pre-fired internal electrode thin film has a multilayer structure formed by a plurality of said dielectric thin films and a plurality of said metal thin films.

7. The production method of an electronic device as set forth in claim 1, wherein a total thickness (t1) of said metal thin films in each of said internal electrode thin films is 0.1 to 1.0 μm.

8. The production method of an electronic device as set forth in claim 1, wherein a total thickness (t2) of said dielectric thin films in each of said internal electrode thin films is 0.02 to 0.2 μm.

9. The production method of an electronic device as set forth in claim 1, wherein a ratio (t2/t1) of a total thickness (t1) of said metal thin films in each of said internal electrode thin films and a total thickness (t2) of said dielectric thin films in each of said internal electrode thin films is 0.05 to 1.

10. The production method of an electronic device as set forth in claim 1 wherein said dielectric thin film is formed by a thin film formation method.

11. The production method of an electronic device as set fort in claim 1 wherein said metal thin film is formed by a thin film formation method.

12. The production method of an electronic device as set forth in claim 10, wherein said thin film formation method is the sputtering method, vapor deposition method or composite plating method.

13. The production method of an electronic device as set forth in claim 1, wherein said dielectric thin film and said green sheet respectively include a dielectric having substantially the same composition.

14. The production method of an electronic device as set forth in claim 1, wherein said metal thin film is a metal thin film including nickel and/or a nickel alloy as a main component thereof.

15. The production method of an electronic device as set forth in claim 1, wherein said multilayer body is fired in an atmosphere having an oxygen partial pressure of 10⁻¹⁰ to 10⁻² Pa at a temperature of 1000° C. to 1300° C.

16. The production method of an electronic device as set forth in claim 1, wherein after firing said multilayer body, annealing is performed in an atmosphere having an oxygen partial pressure of 10⁻² to 100 Pa at a temperature of 1200° C. or lower.

17. An electronic device produced by either one of the methods as set forth in claim 1.

18. A production method of a multilayer ceramic capacitor having an element body, wherein internal electrode layers and dielectric layers are alternately stacked, comprising the steps of:
forming a pre-fired internal electrode thin film having a dielectric thin film and a metal thin film;
alternately stacking green sheets to be dielectric layers after firing and said internal electrode thin films; and
firing a multilayer body of said green sheets and said internal electrode thin films.

19. The production method of a multilayer ceramic capacitor as set forth in claim 18, wherein said dielectric thin film in said pre-fired internal electrode thin film includes at least one kind of BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃.

20. A multilayer ceramic capacitor produced by either one of the methods as set forth in claim 18.
